(19) United States
(12) Patent Application Publication
(10) Pub. No.: US 2019/0244531 A1
(43) Pub. Date: Aug. 8, 2019

(54) SYSTEMS AND METHODS FOR MANAGING LAST MILE DELIVERIES

(71) Applicant: Walmart Apollo, LLC, Bentonville, AR (US)

(72) Inventors: Nathan G. Jones, Bentonville, AR (US); Robert L. Cantrell, Herndon, VA (US); Donald R. High, Noel, MO (US); Todd D. Mattingly, Bentonville, AR (US)

(21) Appl. No.: 16/261,308

(22) Filed: Jan. 29, 2019

Related U.S. Application Data
(60) Provisional application No. 62/625,495, filed on Feb. 2, 2018.

(51) Int. Cl. G08G 5/00; G06Q 10/08; G01C 23/00; G01S 19/07

(52) U.S. Cl. CPC G08G 5/0069; G06Q 10/08355; G08G 5/0034; G01S 19/07; G08G 5/0091; G01C 23/00; G08G 5/0039

(57) ABSTRACT

In some embodiments, apparatuses and methods are provided herein useful to manage a last mile delivery of an unmanned vehicle (UV). In some embodiments, there is provided a system for managing a last mile delivery of a UV including a scout UV configured to perform a dry run delivery to a delivery destination comprising: a differential global positioning satellite (DGPS), an altimeter sensor, a distance sensor, a wind sensor, and a scout control circuit configured to: determine positional location coordinates of the scout UV, determine perimeter coordinates of obstacles along one or more last mile routes, determine a trail of positional location coordinates, provide the trail of positional location coordinates to a delivery UV; and a delivery UV configured to follow the trail of positional location coordinates during an actual delivery of one or more retail products to a delivery destination.

### CROSS-REFERENCE TO RELATED APPLICATION

This application claims the benefit of U.S. Provisional Application No. 62/625,495 filed Feb. 2, 2018, which is incorporated herein by reference in its entirety.

### TECHNICAL FIELD

This invention relates generally to managing last mile deliveries.

### BACKGROUND

Generally, when a retail store receives a retail order from a customer for a delivery of an item, the item is then shipped to the customer from a distribution center via a third-party carrier. The third-party carrier then generally makes a physical delivery to the destination address via a delivery truck.

### BRIEF DESCRIPTION OF THE DRAWINGS

Disclosed herein are embodiments of systems, apparatuses and methods pertaining to managing deliveries. This description includes drawings, wherein:

FIG. 1 illustrates a simplified block diagram of an exemplary system for managing deliveries of an unmanned vehicle (UV) in accordance with some embodiments;

FIG. 2 shows a flow diagram of an exemplary process of managing deliveries of a UV in accordance with some embodiments;

FIG. 3 shows a flow diagram of an exemplary process of managing deliveries of a UV in accordance with some embodiments;

FIG. 4 shows a flow diagram of an exemplary process of managing deliveries of a UV in accordance with some embodiments;

FIG. 5 shows a flow diagram of an exemplary process of managing deliveries of a UV in accordance with some embodiments;

FIG. 6 illustrates an exemplary system for use in implementing methods, techniques, devices, apparatuses, systems, servers, sources and managing deliveries of a UV, in accordance with some embodiments;

FIG. 7 comprises an illustration of blocks as configured in accordance with various embodiments of these teachings;

FIG. 8 comprises an illustration of transactions configured in accordance with various embodiments of these teachings;

FIG. 9 comprises a flow diagram in accordance with various embodiments of these teachings;

FIG. 10 comprises a process diagram as configured in accordance with various embodiments of these teachings;

FIG. 11 comprises an illustration of a delivery record configured in accordance with various embodiments of these teachings; and

FIG. 12 comprise a system diagram configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful for managing last mile deliveries of unmanned vehicles (UVs). In some embodiments, a system for managing last mile deliveries of UVs includes a scout UV. By one approach, the scout UV may perform a dry run delivery on one or more last mile routes to a delivery destination. In one configuration, the scout UV may include a differential global positioning satellite (DGPS) receiver. In one example, the DGPS may receive positioning data from a satellite. Alternatively or in addition to, the DGPS may receive positioning correction data from a DGPS base station. In another configuration, the scout UV may include an altimeter sensor that provides altitude data of the scout UV, a distance sensor that provides distance data of obstacles along the one or more last mile routes, a wind sensor that provides wind data along the one or more last mile routes, and/or a scout control circuit coupled to the DGPS receiver, the altimeter sensor, the distance sensor, and/or the wind sensor. By one approach, the scout control circuit may determine positional location coordinates of the scout UV based on the positioning data and the positioning correction data received by the DGPS receiver and the altitude data provided by the altimeter sensor during the dry run delivery over the one or more last mile routes. By another approach, the scout control circuit may determine perimeter coordinates of the obstacles along the one or more last mile routes based on the distance data, the wind data, and the positional location coordinates. By another approach, the scout control circuit may determine a trail of positional location coordinates based on the positional location coordinates of the scout UV and the perimeter coordinates of the obstacles. In one configuration, the trail of positional location coordinates may establish a delivery path to be followed by a delivery UV over the one or more last mile routes during an actual delivery of one or more retail products associated with one or more retail orders to the delivery destination. By yet another approach, the scout control circuit may provide the trail of positional location coordinates to the delivery UV. In another configuration, the system may include the delivery UV communicatively coupled to the scout UV. By one approach, the delivery UV may follow the trail of positional location coordinates during the actual delivery of the one or more retail products to the delivery destination.

In some embodiments, a method for managing a last mile delivery of an unmanned vehicle (UV) includes determining, by a scout control circuit of a scout UV, positional location coordinates of the scout UV based on positioning data and positioning correction data received from a differential global positioning satellite (DGPS) receiver and altitude data received from an altimeter sensor during a dry run delivery of the scout UV over one or more last mile routes. By one approach, the method may include determining, by the scout control circuit, perimeter coordinates of obstacles along the one or more last mile routes based on distance data received from a distance sensor, wind data received from a wind sensor, and the positional location coordinates. By another approach, the method may include determining, by the scout control circuit, a trail of positional location coordinates based on the positional location coordinates of the scout UV and the perimeter coordinates of the obstacles. In one configuration, the trail of positional location coordinates may establish a delivery path to be followed by a delivery UV over the one or more last mile routes during an actual delivery of one or more retail orders to a delivery destination. By yet another approach, the method may include providing, by the scout control circuit, the trail of positional location coordinates to the delivery UV. By yet another approach, the method may include following, by the delivery UV, the trail of positional location coordinates during the actual delivery of the one or more retail products to the delivery destination.

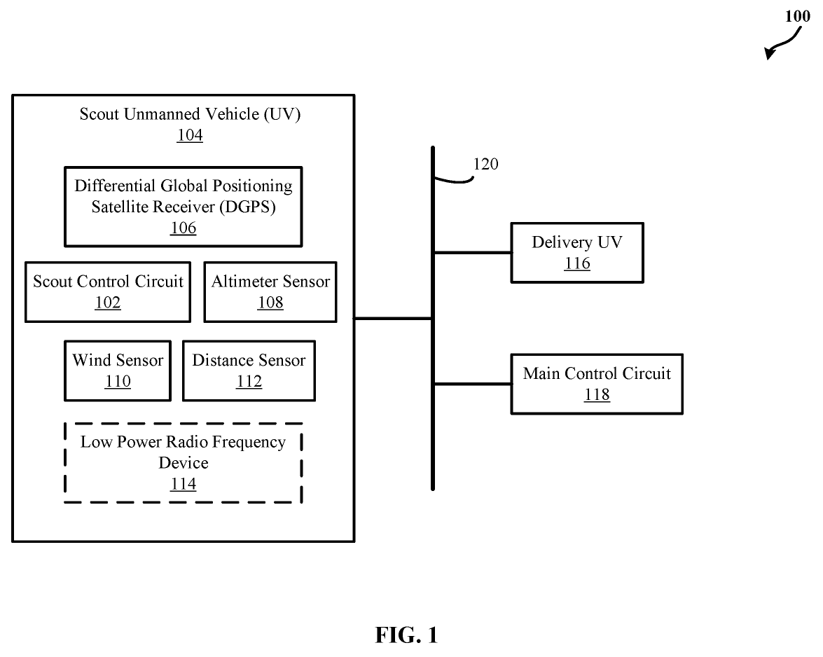

FIG. 1 illustrates a simplified block diagram of an exemplary system 100 for managing deliveries of an unmanned vehicle (UV) in accordance with some embodiments. The exemplary system 100 includes a scout unmanned vehicle(s) (UVs) 104. In one configuration, the system 100 may include a delivery UV(s) 116 and a main control circuit(s) 118. By one approach, the scout UV 104, the delivery UV 116 and/or the main control circuit 118 may be communicatively coupled through a communication network 120. In one example, the communication network 120 may include a cellular network, an internet network, a WiFi network, a blockchain network, among other communication networks that are configured and facilitate communications between one device to one or more devices (e.g., the scout UV 104, the delivery UV 116, the main control circuit 118, etc.). In one configuration, the scout UV 104 may include a differential global positioning satellite receiver (DGPS) 106, a scout control circuit 102, an altimeter sensor 108, a wind sensor 110, a distance sensor 112, and/or a low power radio frequency device 114.

In an illustrative non-limiting example, the scout UV 104 may perform a dry run delivery on one or more “last mile” routes to one or more delivery destinations, and generate one or more series of geographical coordinates leading to the one or more delivery destinations and/or threshold variations along the series. For example, generations of series of geographical coordinates leading to delivery destinations along the “last mile” routes enable the delivery UV 116 to be equipped with a minimum number of sensors and/or redirect a substantial portion of the delivery UV's 116 battery power towards delivery of retail items while making the delivery, instead of spending substantial portions of processing and/or battery power towards avoiding obstacles along the “last mile” route. By one approach, the main control circuit 118 may receive a retail order for one or more items from a customer to be delivered to the delivery destination. In one configuration, the main control circuit 118 may dispatch the scout UV 104 to perform the dry run delivery. In one example, the last mile routes may include one or more routes having a threshold distance that is between the delivery destination and about 300 feet from the delivery destination. In such an example, one last mile route may include a distance between a location on a delivery route and the delivery destination. In another example, the last mile route may correspond to a last leg of the delivery route proximate to and including the delivery destination. In one scenario, the last leg may correspond to less than and/or equal to a mile from the delivery destination. By one approach, the DGPS receiver 106 may receive positioning data from a satellite. The satellite may include Global Positioning Satellite (GPS) and Galileo, among other satellite navigation systems configured to provide location data. By another approach, the DGPS receiver 106 may receive positioning correction data from a DGPS base station. In one example, the scout control circuit 102 may combine the positioning correction data with the positioning data and may enable the scout UV 104 to deliver the items to the delivery destination within a threshold accuracy in centimeters instead of meters. Alternatively or in addition to, the altimeter sensor 108 may provide altitude data of the scout UV 104. In one example, the scout control circuit 102 may combine the positioning correction data and the positioning data received from the DGPS receiver 106 with the altitude data to enable the scout control circuit 102 to determine its three-dimensional (3D) location relative to earth's surface, and thereby facilitating the scout UVs 104 navigation around obstacles on the last mile route. By one approach, the obstacles found along the last mile route are fixed, stationary, and/or permanent obstacles but capable of swaying under certain weather and/or wind speed conditions from their nominal and/or usual position. In another example, the distance sensor 112 may provide the scout UV 104 distance data of obstacles along the last mile routes. By one approach, the distance sensor 112 may include infrared sensor, ultrasonic sensor, and radar sensor, among other distance sensors capable of determining distance between one object to another object and/or electronic device, including distance between the scout UV and one or more external objects positioned along and adjacent the route. Further, in some instances, the one or more distance sensors may determine distances between two or more external objects or parts of one or more external objects along or adjacent the route. In another example, the scout control circuit 102 may use the distance data of the distance sensor 112 in combination with the positioning correction data and the positioning data received from the DGPS receiver 106 to determine distances of the obstacles on the last mile route. In another example, the wind sensor 110 may provide wind data during a particular weather condition along the last mile routes. In one configuration, the scout control circuit 102 may determine a minimum and/or a maximum sway of an obstacle under a particular wind speed and/or weather conditions.

In an illustrative non-limiting example, the obstacle or portions of the obstacle might sway a distance of 5 centimeters from a nominal positional location coordinate of the obstacle when subjected to a wind speed condition of 4 Knots during a slightly overcast weather condition. In another illustrative non-limiting example, the obstacle may have a particular nominal positional location coordinate when the weather condition is unbreezy and sunny having less than 1 Knot of wind speed and during this weather condition the obstacle may only sway less than 1 centimeters. In such an example, the scout control circuit 102 may determine that for this particular portion of the last mile route where this particular obstacle is found, average positional location coordinates of this particular obstacle may correspond to particular values based on historical data obtained by the scout control circuit 102 during the scout UV's 104 multiple dry runs. In such an example, the scout control circuit 102 may assign the particular values to be the nominal positional location coordinates of the particular obstacle. By one approach, the scout control circuit 102 may determine a factor value to add to nominal positional location coordinates based on a difference between perimeter coordinates of an obstacle during a particular weather and/or wind speed condition and the nominal positional location coordinates associated with the obstacle. In one configuration, a perimeter coordinate may define one or more spatial boundaries of a particular obstacle during and corresponding to a particular weather and/or wind speed condition. By another approach, the one or more spatial boundaries of the particular obstacle may correspond to a threshold limit that the delivery UV 116 may be allowed to deviate from a portion of a trail of positional location coordinates proximate the particular obstacle. For example, during a first dry run, the scout control circuit 102 may determine that a first factor value of 7 may be associated with an obstacle when a first weather condition is rainy with a wind speed of 14 Knots. In another example, during a second dry run, the scout control circuit 102 may determine that a second factor value of 3 may be associated with the obstacle when a second weather condition is sunny. with a wind speed of 5 Knots. In yet another example, the scout control circuit 102 may determine that during an abrupt maneuver under the second weather condition the delivery UV 116 may, in an illustrative example, deviate about 10 centimeters from the portion of the trail to avoid colliding with the obstacle.

In some embodiments, the database may store a plurality of factor values determined by the scout control circuit 102. Alternatively or in addition to, the scout control circuit 102 may associate the plurality of factor values with a plurality of weather conditions and/or a plurality of wind speed conditions and/or a plurality of obstacles found on a plurality of last mile routes to one or more particular delivery destinations in the database. As such, in one configuration, a trail of positional location coordinates provided to and followed by the delivery UV 116 may be determined by the scout control circuit 102 based on a plurality of positional location coordinates traversed by the scout control circuit 102 during a dry run on the last mile route and a plurality of perimeter coordinates of obstacles found on the last mile route that were determined by the scout control circuit 102 based on nominal positional location coordinates corresponding to the obstacles and one or more factor values associated with similar weather and/or wind speed condition during an actual delivery of the delivery UV 116.

In some embodiments, the scout control circuit 102 may trigger the database to initiate storage of determined positional location coordinates as the scout UV 104 traverses through the last mile routes during a dry run delivery. For example, as the scout UV 104 traverses through the last mile routes, the scout UV 104, in cooperation with the scout control circuit 102 and one or more of the DGPS receiver 106, the altimeter sensor 108, the distance sensor 112, and the wind sensor 110, navigates through obstacles along the last mile routes and, as a result, creates one or more tracks (e.g., series of geographical coordinates) and/or threshold variations along the last mile routes that avoid the obstacles. In such an example, the database may store the one or more tracks and/or the threshold variations along the last mile routes as positional location coordinates as the scout UV 104 traverses through the last mile routes. By one approach, the scout control circuit 102 may trigger, at a first time, the database to start storing data when the scout control circuit 102 determines that the scout UV 104 has reached a start point of a route of the last mile routes. By another approach, the scout control circuit 102 may trigger, at a second time, the database to stop storage of the determined positional location coordinates when the scout UV 104 reaches an end point of the route. As such, the scout control circuit 102 may associate in the database positional location coordinates determined by the scout control circuit 102 while the scout UV 104 travels and/or traverses between the start and end points of the route of the last mile routes. For example, a trail of positional location coordinates may include a series of global positioning satellite (GPS) coordinates spaced long the route starting from a first GPS coordinate corresponding to an outer edge of one or more last mile routes and ending at a second GPS coordinate corresponding to a delivery destination associated with a retail order. In another example, each GPS coordinate in the series of GPS coordinates may be separated or apart from another GPS coordinate in the series by and/or at least within a threshold value of a particular centimeter or a fraction thereof. In an illustrative non-limiting example, each GPS coordinate in a series may each be, for example, 1 centimeter (+/−a threshold value) apart from the other GPS coordinates in the series. In another example, one or more GPS coordinates in a series may be variously separated from another one or more GPS coordinates in the series by a centimeter value that is within a threshold value between a first particular centimeter or a fraction thereof and a second particular centimeter or a fraction thereof. To illustrate, in one scenario, a first distance between a first GPS coordinate and a second GPS coordinate may be 10.3 centimeters, a second distance between the second GPS coordinate and a third GPS coordinate may be 9.7 centimeters, and a third distance between the third GPS coordinate and a fourth GPS coordinate may be 10.5 centimeters. In such a scenario, a threshold value applicable to each distances may be any value that is between 0.2 centimeter through 1.0 centimeter.

By one approach, while traversing through the last mile routes, the scout control circuit 102 may determine perimeter coordinates of the obstacles along the last mile routes based on the distance data, the wind data, and the positional location coordinates. By one example, a perimeter coordinate of an obstacle may correspond to a plurality of positional coordinates defining a perimeter area of the obstacle. By another example, a perimeter coordinate of an obstacle may correspond to a plurality of positional coordinates including only those positional coordinates that are relevant to the last mile routes. In one scenario, the perimeter area may correspond to a box having at least eight positional coordinates of the eight corner points defining the box. In another scenario, the perimeter area may correspond to a portion of the box having at least four positional coordinates that are proximate a portion of the last mile routes. In another scenario, the perimeter area may correspond to a portion of a pyramid having at least three positional coordinates of the three corner points defining a side of the pyramid. By another example, the perimeter coordinates of the obstacles may include a maximum and/or a minimum perimeter coordinates when the obstacle is under various weather and/or wind speed conditions over a period of time. For example, under a very windy condition, an obstacle's maximum sway may be 30 centimeters from a nominal position of the obstacle during an average day. In such an example, a maximum perimeter coordinates of the obstacle may include the 30 centimeters from a nominal perimeter coordinates of the obstacle. In another example, the obstacle's minimum sway may occur during an average day. As such, the perimeter coordinates of the obstacle during the average day may be within a small threshold value from the nominal perimeter coordinates of the obstacle. By one approach, a maximum and/or a minimum perimeter coordinates of an obstacle are determined overtime by multiple different passes of the scout UV 104 during various weather and/or wind speed conditions. By yet another approach, the scout control circuit 102 may determine a trail of positional location coordinates based on the positional location coordinates of the scout UV and the perimeter coordinates of the obstacles. In such an approach, the trail of positional location coordinates may establish a delivery path to be followed by a delivery UV over the one or more last mile routes during an actual delivery of one or more retail products associated with one or more retail orders to the delivery destination. In one example, the perimeter coordinates of the obstacles along the last mile routes may be determined, by the scout control circuit 102 over a plurality of different periods of time to account for varying wind data during a plurality of weather and/or wind speed patterns. In another example, the scout control circuit 102 may associate a particular determined perimeter coordinate of a particular obstacle with at least one of: a corresponding one of the varying wind data, a corresponding one of the plurality of weather patterns, and/or a corresponding one of the period of time. In yet another example, the scout control circuit 102 may initiate storage of the associated particular determined perimeter coordinate of a plurality of associated particular determined perimeter coordinates to a database that is communicatively coupled to the scout control circuit 102. In yet another example, the scout control circuit 102 may receive a forecasted weather and/or wind speed pattern corresponding to a period of time of a delivery of one or more retail orders to a delivery destination by the delivery UV 116. By one approach, the scout control circuit 102 may access the database to determine the particular determined perimeter coordinate corresponding to the particular obstacle and the weather pattern that is substantially matching the forecasted weather pattern. In one scenario, the determination of the trail of positional location coordinates may be based on the particular perimeter coordinate corresponding to the particular obstacle and the forecasted weather pattern. In one example, one or more last mile routes may include one or more routes having a threshold distance between an initial start of descent of the delivery UV 116 to the delivery destination. In another example, the delivery UV 116 may start following the trail of positional location coordinates when the delivery UV 116 reaches a threshold distance from the delivery destination. By one approach, the delivery UV 116 may start following the trail of positional location coordinates when the delivery UV's 116 start descending at a positional location coordinate of the trail that falls anywhere between the delivery destination and about 300 feet from the delivery destination. In some embodiments, one or more functions and/or operations as described herein as being performed by the scout control circuit 102 may, alternatively or in addition to, be performed by the main control circuit 118. For example, alternatively or in addition to, the main control circuit 118 may determine perimeter coordinates of obstacles in similar operations and/or methods as the scout control circuit 102.

In one configuration, the delivery UV 116 may follow the trail of positional location coordinates during an actual delivery of one or more retail products to a delivery destination. In such a configuration, in following the trail of positional location coordinates, the delivery UV 116 may minimally operate sensors of the delivery UV 116 and/or a delivery UV control circuit may perform faster operational processing during an actual delivery since trail of positional location coordinates takes into account perimeter coordinates of obstacles on last mile routes under similar weather condition and/or wind condition during the actual delivery, and thus, bypassing intensive processing of the delivery UV control circuit just to detect and avoid obstacles that are usually found and/or stationary along the last mile routes. As such, the delivery UV 116 may efficiently use and/or extend power usage of a battery associated with the delivery UV 116 based on elimination of processing for detection and avoidance of obstacles that are usually found and/or stationary along the last mile routes. In other words, the delivery UV 116 may, on default, expect no obstacle in one or more delivery paths of the last mile routes when the delivery UV 116 follows the trail of positional location coordinates.

In some embodiments, the delivery UV 116 may detect an unexpected obstacle blocking a portion of a delivery path along the trail of positional location coordinates. By one approach, the delivery UV 116 may consider one or more particular perimeter coordinates of perimeter coordinates of one or more particular obstacles proximate the portion of the delivery path when avoiding the unexpected obstacle. By another approach, the delivery UV 116 may provide an alert message to the main control circuit 118 indicating that the unexpected obstacle blocking the portion of the delivery path. Alternatively or in addition to, the main control circuit 118 may receive the trail of positional location coordinates from the scout UV 104 at substantially the same time as when the delivery UV 116 receives the trail of positional location coordinates. By one approach, the main control circuit 118 may provide at least one of: a warning message to one or more other delivery UVs having another delivery path comprising the portion of the delivery path and a modified delivery path to the one or more other delivery UVs. In yet some embodiments, the scout control circuit 102 may communicate with the delivery UV 116 over a blockchain network. For example, the trail of positional location coordinates may be provided to the delivery UV 116 over the blockchain network to enhance security and authenticity of the trail of positional location coordinates received by the delivery UV 116 from the scout UV 104 and/or the main control circuit 118. In such an example, the low power radio frequency device 114 of the scout UV 104 may transmit the trail of positional location coordinates over the blockchain network. Yet in some embodiments, system and/or methods described herein for managing a last mile delivery of an unmanned vehicle (UV) may similarly and/or equally applicable for managing interstore and/or interfacility transfer of a UV.

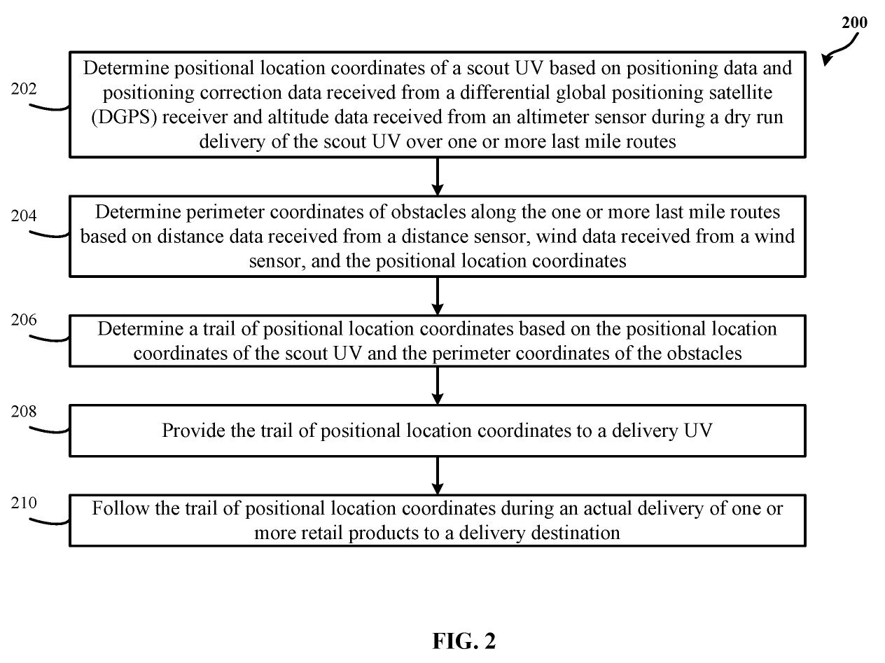

FIG. 2 illustrates a flow diagram of an exemplary method 200 of managing last mile deliveries of a UV in accordance with some embodiments. By one approach, the exemplary method 200 may be implemented in the system 100 of FIG. 1. By another approach, one or more steps in the method 200 may be implemented in the scout control circuit 102, the main control circuit 118, and/or the delivery UV 116. The method 200 includes, at step 202, determining positional location coordinates of an scout UV based on positioning data and positioning correction data received from a differential global positioning satellite (DGPS) receiver and altitude data received from an altimeter sensor during a dry run delivery of the scout UV over one or more last mile routes. In one configuration, the method 200 may include, at step 204, determining perimeter coordinates of obstacles along the one or more last mile routes based on distance data received from a distance sensor, wind data received from a wind sensor, and the positional location coordinates. In another configuration, the method 200 may include, at step 206, determining a trail of positional location coordinates based on the positional location coordinates of the scout UV and the perimeter coordinates of the obstacles. In one example, the trail of positional location coordinates may establish a delivery path to be followed by a delivery UV over the one or more last mile routes during an actual delivery of one or more retail orders to a delivery destination. In another configuration, the method 200 may include, at step 208, providing the trail of positional location coordinates to the delivery UV. In yet another configuration, the method 200 may include following the trail of positional location coordinates during the actual delivery of the one or more retail products to the delivery destination, at step 210.

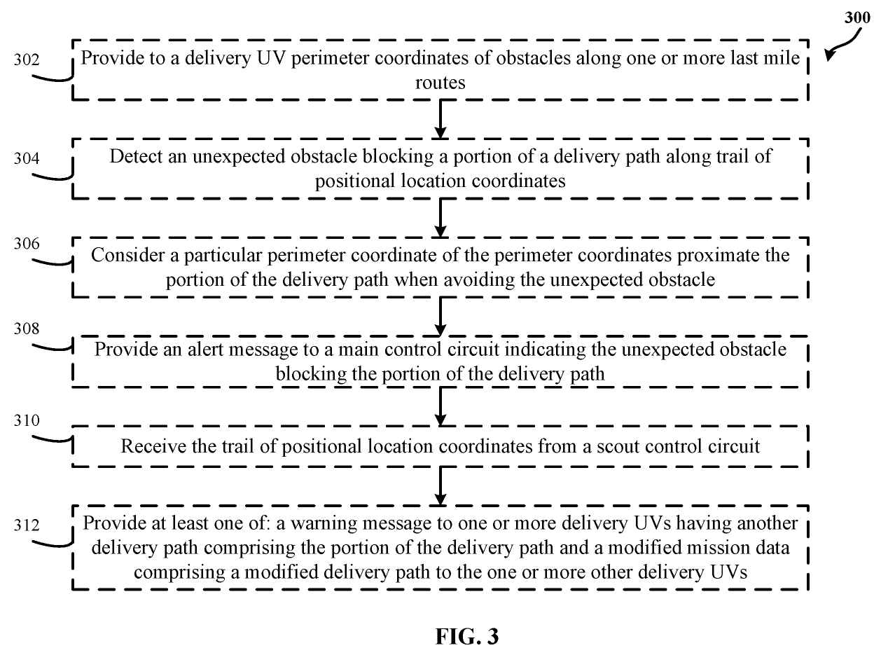

FIG. 3 illustrates a flow diagram of an exemplary method 300 of managing last mile deliveries of a UV in accordance with some embodiments. By one approach, the exemplary method 300 may be implemented in the system 100 of FIG. 1. By another approach, one or more steps in the method 300 may be implemented in the scout control circuit 102, the main control circuit 118, and/or the delivery UV 116. By yet another approach, the method 300 and/or one or more steps of the method may optionally be included in and/or performed in cooperation with the method 200 of FIG. 2. The method 300 includes, at step 302, providing to a delivery UV perimeter coordinates of obstacles along one or more last mile routes. By another approach, the method 300 may include, at step 304, detecting an unexpected obstacle blocking a portion of a delivery path along a trail of positional location coordinates. By another approach, the method 300 may include, at step 306, considering a particular perimeter coordinate of the perimeter coordinates proximate the portion of the delivery path when avoiding the unexpected obstacle. By another approach, the method 300 may include providing an alert message to a main control circuit indicating the unexpected obstacle blocking the portion of the delivery path, at step 308. In one example, the main control circuit may be remote from and communicatively coupled to the delivery UV and the scout UV. By one approach, the method 300 may include, at step 310, receiving the trail of positional location coordinates from the scout control circuit. By yet another approach, the method 300 may include, at step 312, providing a warning message to one or more delivery UVs having another delivery path comprising the portion of the delivery path and/or a modified mission data comprising a modified delivery path to the one or more other delivery UVs.

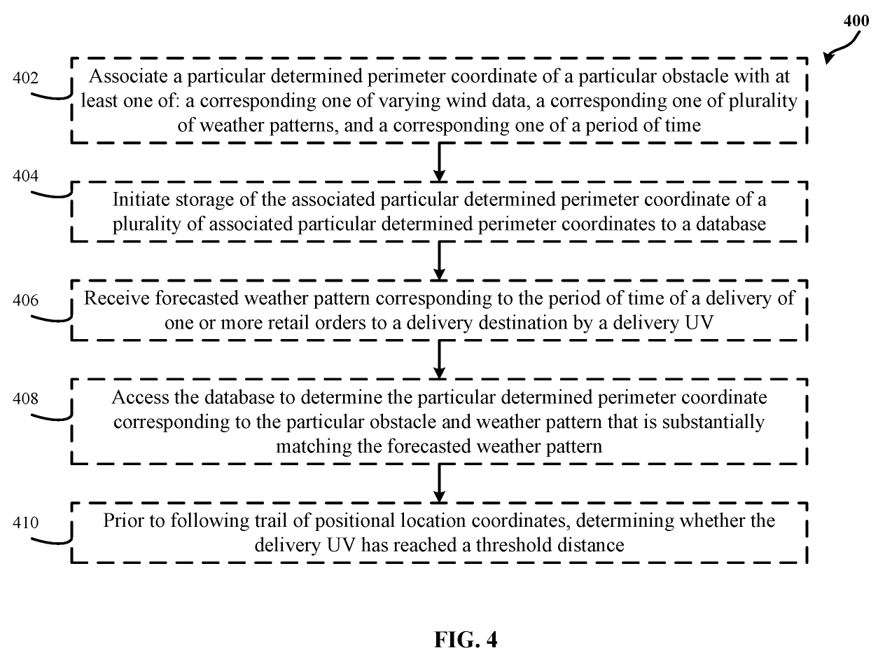

FIG. 4 illustrates a flow diagram of an exemplary method 400 of managing last mile deliveries of a UV in accordance with some embodiments. By one approach, the exemplary method 400 may be implemented in the system 100 of FIG. 1. By another approach, one or more steps in the method 400 may be implemented in the scout control circuit 102, the main control circuit 118, and/or the delivery UV 116. By yet another approach, the method 400 and/or one or more steps of the method may optionally be included in and/or performed in cooperation with the method 200 of FIG. 2 and/or the method 300 of FIG. 3. In one configuration, when perimeter coordinates of obstacles along one or more last mile routes may be determined over a plurality of different periods of time to account for varying wind data during a plurality of weather patterns, the method 400 may include, at step 402, associating a particular determined perimeter coordinate of a particular obstacle with a corresponding one of the varying wind data, a corresponding one of the plurality of weather patterns, and/or a corresponding one of the period of time. Alternatively or in addition to, the method may include, at step 404, initiating storage of the associated particular determined perimeter coordinate of a plurality of associated particular determined perimeter coordinates to a database that is communicatively coupled the scout control circuit and the main control circuit. In another configuration, the method 400 may include, at step 406, receiving forecasted weather pattern corresponding to a period of time of the delivery of the one or more retail orders to the delivery destination by the delivery UV. In such a configuration, the method 400 may include, at step 408, accessing the database to determine the particular determined perimeter coordinate corresponding to the particular obstacle and the weather pattern that is substantially matching the forecasted weather pattern. In one example, the determining of the trail of positional location coordinates may be based on the particular perimeter coordinate corresponding to the particular obstacle and the forecasted weather pattern. In another example, the one or more last mile routes may include one or more routes having a threshold distance between an initial start of descent of the delivery UV to the delivery destination. In yet another configuration, prior to following of the trail of positional location coordinates, the method 400 may include, at step 410, determining whether the delivery UV has reached the threshold distance.

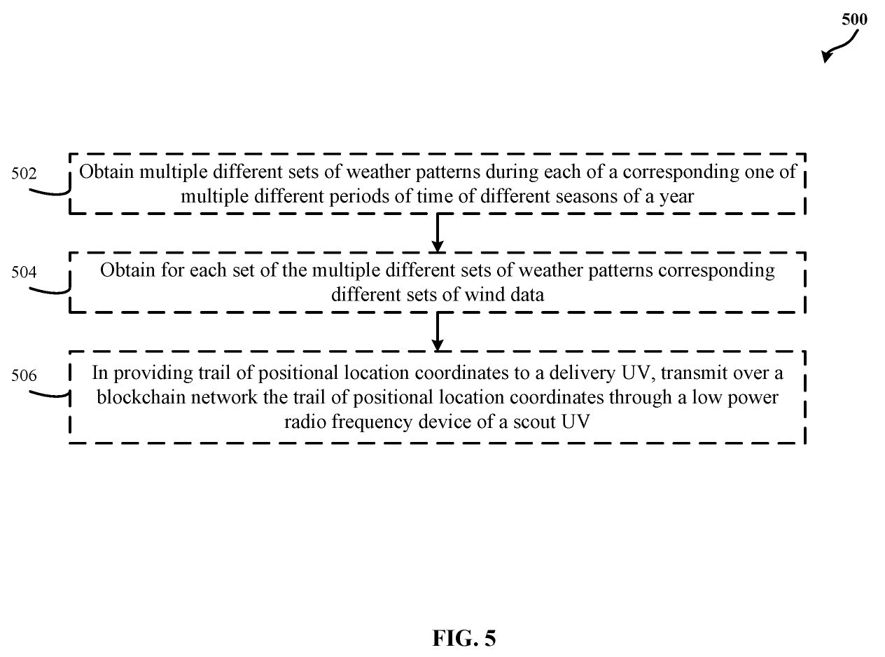

FIG. 5 illustrates a flow diagram of an exemplary method 500 of managing last mile deliveries of a UV in accordance with some embodiments. By one approach, the exemplary method 500 may be implemented in the system 100 of FIG. 1. By another approach, one or more steps in the method 500 may be implemented in the scout control circuit 102, the main control circuit 118, and/or the delivery UV 116. By yet another approach, the method 500 and/or one or more steps of the method may optionally be included in and/or performed in cooperation with the method 200 of FIG. 2, the method 300 of FIG. 3, and/or the method 400 of FIG. 4. In one configuration, the method 500 includes, at step 502, obtaining multiple different sets of weather patterns during each of a corresponding one of multiple different periods of time of different seasons of a year. In another configuration, the method 500 may include, at step 504, obtaining for each set of the multiple different sets of weather patterns corresponding different sets of wind data. In yet another configuration, in providing the trail of positional location coordinates to the delivery UV, the method 500 may include transmitting over a blockchain network the trail of positional location coordinates through a low power radio frequency device of the scout UV, at step 506.

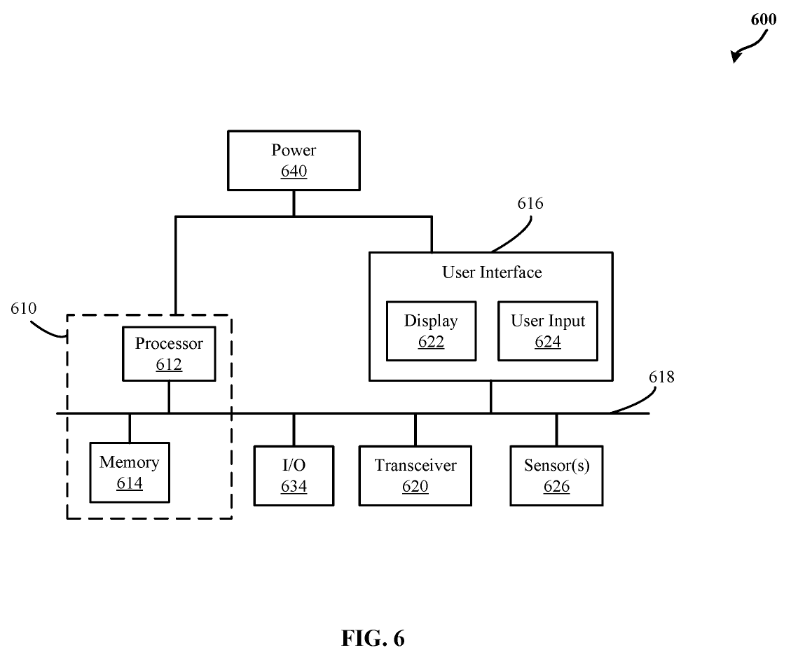

Further, the circuits, circuitry, systems, devices, processes, methods, techniques, functionality, services, servers, sources and the like described herein may be utilized, implemented and/or run on many different types of devices and/or systems. FIG. 6 illustrates an exemplary system 600 that may be used for implementing any of the components, circuits, circuitry, systems, functionality, apparatuses, processes, or devices of the system 100 of FIG. 1, the method 200 of FIG. 2, the method 300 of FIG. 3, the method 400 of FIG. 4, the method 500 of FIG. 5 and/or other above or below mentioned systems or devices, or parts of such circuits, circuitry, functionality, systems, apparatuses, processes, or devices. For example, the system 600 may be used to implement some or all of the system for managing a last mile delivery of a UV, the scout UV 104, the scout control circuit 102, the DGPS 106, the altimeter sensor 108, the wind sensor 110, the distance sensor 112, the low power radio frequency device 114, the delivery UV 116, the main control circuit 118, and/or other such components, circuitry, functionality and/or devices. However, the use of the system 600 or any portion thereof is certainly not required.

By way of example, the system 600 may comprise a processor module (or a control circuit) 612, memory 614, and one or more communication links, paths, buses or the like 618. Some embodiments may include one or more user interfaces 616, and/or one or more internal and/or external power sources or supplies 640. The control circuit 612 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 612 can be part of control circuitry and/or a control system 610, which may be implemented through one or more processors with access to one or more memory 614 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 600 may be used to implement one or more of the above or below, or parts of, components, circuits, systems, processes and the like. For example, the system 600 may implement the system for managing a last mile delivery of a UV 100 with the scout control circuit 102 and/or the main control circuit 118 being the control circuit 612.

The user interface 616 can allow a user to interact with the system 600 and receive information through the system. In some instances, the user interface 616 includes a display 622 and/or one or more user inputs 624, such as buttons, touch screen, track ball, keyboard, mouse, etc., which can be part of or wired or wirelessly coupled with the system 600. Typically, the system 600 further includes one or more communication interfaces, ports, transceivers 620 and the like allowing the system 600 to communicate over a communication bus, a distributed computer and/or communication network (e.g., a local area network (LAN), the Internet, wide area network (WAN), etc.), communication link 618, other networks or communication channels with other devices and/or other such communications or combination of two or more of such communication methods. Further the transceiver 620 can be configured for wired, wireless, optical, fiber optical cable, satellite, or other such communication configurations or combinations of two or more of such communications. Some embodiments include one or more input/output (I/O) interface 634 that allow one or more devices to couple with the system 600. The I/O interface can be substantially any relevant port or combinations of ports, such as but not limited to USB, Ethernet, or other such ports. The I/O interface 634 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 626 to provide information to the system and/or sensor information that is communicated to another component, such as the scout UV 104, the scout control circuit 102, the DGPS 106, the altimeter sensor 108, the wind sensor 110, the distance sensor 112, the low power radio frequency device 114, the delivery UV 116, the main control circuit 118, etc. The sensors can include substantially any relevant sensor, such as temperature sensors, distance measurement sensors (e.g., optical units, sound/ultrasound units, etc.), optical based scanning sensors to sense and read optical patterns (e.g., bar codes), radio frequency identification (RFID) tag reader sensors capable of reading RFID tags in proximity to the sensor, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 600 comprises an example of a control and/or processor-based system with the control circuit 612. Again, the control circuit 612 can be implemented through one or more processors, controllers, central processing units, logic, software and the like. Further, in some implementations the control circuit 612 may provide multiprocessor functionality. The memory 614, which can be accessed by the control circuit 612, typically includes one or more processor readable and/or computer readable media accessed by at least the control circuit 612, and can include volatile and/or nonvolatile media, such as RAM, ROM, EEPROM, flash memory and/or other memory technology. Further, the memory 614 is shown as internal to the control system 610; however, the memory 614 can be internal, external or a combination of internal and external memory. Similarly, some or all of the memory 614 can be internal, external or a combination of internal and external memory of the control circuit 612. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network. The memory 614 can store code, software, executables, scripts, data, content, lists, programming, programs, log or history data, user information, customer information, product information, and the like. While FIG. 6 illustrates the various components being coupled together via a bus, it is understood that the various components may actually be coupled to the control circuit and/or one or more other components directly.

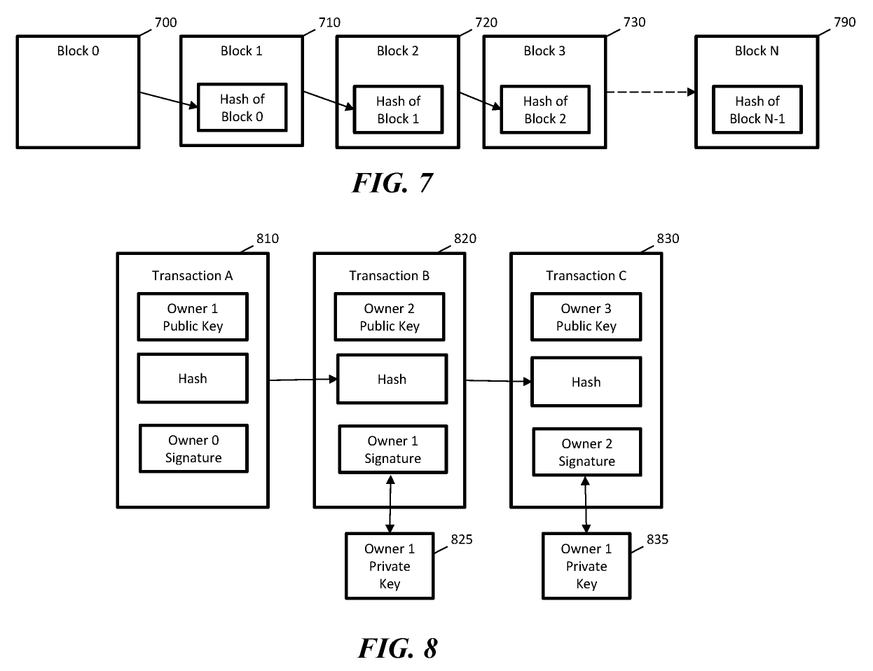

Descriptions of some embodiments of blockchain technology are provided with reference to FIG. 7-12 herein. In some embodiments of the invention described above, blockchain technology may be utilized to record communications between unmanned vehicles (UVs), control circuits, electronic devices, or any combination thereof, sales record/delivery record/transactions/etc. One or more of the UVs, the control circuits, and/or the electronic devices described herein may comprise a node in a distributed blockchain system storing a copy of the blockchain record. Updates to the blockchain may comprise transfer of items/sales/new data/positional location coordinates/trails of positional location coordinates/perimeter coordinates of obstacles/delivery of retail products/and/or any communications to effectuate some embodiments of the invention described above, and one or more nodes on the system may be configured to incorporate one or more updates into blocks to add to the distributed database.

Distributed database and shared ledger database generally refer to methods of peer-to-peer record keeping and authentication in which records are kept at multiple nodes in the peer-to-peer network instead of kept at a trusted party. A blockchain may generally refer to a distributed database that maintains a growing list of records in which each block contains a hash of some or all previous records in the chain to secure the record from tampering and unauthorized revision. A hash generally refers to a derivation of original data. In some embodiments, the hash in a block of a blockchain may comprise a cryptographic hash that is difficult to reverse and/or a hash table. Blocks in a blockchain may further be secured by a system involving one or more of a distributed timestamp server, cryptography, public/private key authentication and encryption, proof standard (e.g. proof-of-work, proof-of-stake, proof-of-space), and/or other security, consensus, and incentive features. In some embodiments, a block in a blockchain may comprise one or more of a data hash of the previous block, a timestamp, a cryptographic nonce, a proof standard, and a data descriptor to support the security and/or incentive features of the system.

In some embodiments, a blockchain system comprises a distributed timestamp server comprising a plurality of nodes configured to generate computational proof of record integrity and the chronological order of its use for content, trade, and/or as a currency of exchange through a peer-to-peer network. In some embodiments, when a blockchain is updated, a node in the distributed timestamp server system takes a hash of a block of items to be timestamped and broadcasts the hash to other nodes on the peer-to-peer network. The timestamp in the block serves to prove that the data existed at the time in order to get into the hash. In some embodiments, each block includes the previous timestamp in its hash, forming a chain, with each additional block reinforcing the ones before it. In some embodiments, the network of timestamp server nodes performs the following steps to add a block to a chain: 1) new activities are broadcasted to all nodes, 2) each node collects new activities into a block, 3) each node works on finding a difficult proof-of-work for its block, 4) when a node finds a proof-of-work, it broadcasts the block to all nodes, 5) nodes accept the block only if activities are authorized, and 6) nodes express their acceptance of the block by working on creating the next block in the chain, using the hash of the accepted block as the previous hash. In some embodiments, nodes may be configured to consider the longest chain to be the correct one and work on extending it. A digital currency implemented on a blockchain system is described by Satoshi Nakamoto in “Bitcoin: A Peer-to-Peer Electronic Cash System” (http://bitcoin.org/bitcoin.pdf), the entirety of which is incorporated herein by reference.

Now referring to FIG. 7, an illustration of a blockchain according to some embodiments is shown. In some embodiments, a blockchain comprises a hash chain or a hash tree in which each block added in the chain contains a hash of the previous block. In FIG. 7, block 0 700 represents a genesis block of the chain. Block 1 710 contains a hash of block 0 700, block 2 720 contains a hash of block 1 710, block 3 730 contains a hash of block 2 720, and so forth. Continuing down the chain, block N contains a hash of block N−1. In some embodiments, the hash may comprise the header of each block. Once a chain is formed, modifying or tampering with a block in the chain would cause detectable disparities between the blocks. For example, if block 1 is modified after being formed, block 1 would no longer match the hash of block 1 in block 2. If the hash of block 1 in block 2 is also modified in an attempt to cover up the change in block 1, block 2 would not then match with the hash of block 2 in block 3. In some embodiments, a proof standard (e.g. proof-of-work, proof-of-stake, proof-of-space, etc.) may be required by the system when a block is formed to increase the cost of generating or changing a block that could be authenticated by the consensus rules of the distributed system, making the tampering of records stored in a blockchain computationally costly and essentially impractical. In some embodiments, a blockchain may comprise a hash chain stored on multiple nodes as a distributed database and/or a shared ledger, such that modifications to any one copy of the chain would be detectable when the system attempts to achieve consensus prior to adding a new block to the chain. In some embodiments, a block may generally contain any type of data and record. In some embodiments, each block may comprise a plurality of transaction and/or activity records.

In some embodiments, blocks may contain rules and data for authorizing different types of actions and/or parties who can take action. In some embodiments, transaction and block forming rules may be part of the software algorithm on each node. When a new block is being formed, any node on the system can use the prior records in the blockchain to verify whether the requested action is authorized. For example, a block may contain a public key of an owner of an asset that allows the owner to show possession and/or transfer the asset using a private key. Nodes may verify that the owner is in possession of the asset and/or is authorized to transfer the asset based on prior transaction records when a block containing the transaction is being formed and/or verified. In some embodiments, rules themselves may be stored in the blockchain such that the rules are also resistant to tampering once created and hashed into a block. In some embodiments, the blockchain system may further include incentive features for nodes that provide resources to form blocks for the chain. For example, in the Bitcoin system, “miners” are nodes that compete to provide proof-of-work to form a new block, and the first successful miner of a new block earns Bitcoin currency in return.

Now referring to FIG. 8, an illustration of blockchain based transactions according to some embodiments is shown. In some embodiments, the blockchain illustrated in FIG. 8 comprises a hash chain protected by private/public key encryption. Transaction A 810 represents a transaction recorded in a block of a blockchain showing that owner 1 (recipient) obtained an asset from owner 0 (sender). Transaction A 810 contains owner's 1 public key and owner 0's signature for the transaction and a hash of a previous block. When owner 1 transfers the asset to owner 2, a block containing transaction B 820 is formed. The record of transaction B 820 comprises the public key of owner 2 (recipient), a hash of the previous block, and owner 1's signature for the transaction that is signed with the owner 1's private key 825 and verified using owner 1's public key in transaction A 810. When owner 2 transfers the asset to owner 3, a block containing transaction C 830 is formed. The record of transaction C 830 comprises the public key of owner 3 (recipient), a hash of the previous block, and owner 2's signature for the transaction that is signed by owner 2's private key 835 and verified using owner 2's public key from transaction B 820. In some embodiments, when each transaction record is created, the system may check previous transaction records and the current owner's private and public key signature to determine whether the transaction is valid. In some embodiments, transactions are be broadcasted in the peer-to-peer network and each node on the system may verify that the transaction is valid prior to adding the block containing the transaction to their copy of the blockchain. In some embodiments, nodes in the system may look for the longest chain in the system to determine the most up-to-date transaction record to prevent the current owner from double spending the asset. The transactions in FIG. 8 are shown as an example only. In some embodiments, a blockchain record and/or the software algorithm may comprise any type of rules that regulate who and how the chain may be extended. In some embodiments, the rules in a blockchain may comprise clauses of a smart contract that is enforced by the peer-to-peer network.

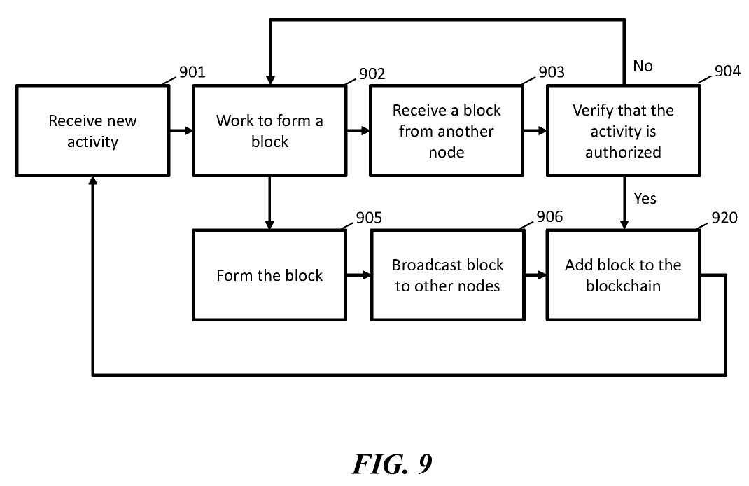

Now referring to FIG. 9, a flow diagram according to some embodiments is shown. In some embodiments, the steps shown in FIG. 9 may be performed by a processor-based device, such as a computer system, a server, a distributed server, a timestamp server, a blockchain node, and the like. In some embodiments, the steps in FIG. 9 may be performed by one or more of the nodes in a system using blockchain for record keeping.

In step 901, a node receives a new activity. The new activity may comprise an update to the record being kept in the form of a blockchain. In some embodiments, for blockchain supported digital or physical asset record keeping, the new activity may comprise a asset transaction. In some embodiments, the new activity may be broadcasted to a plurality of nodes on the network prior to step 901. In step 902, the node works to form a block to update the blockchain. In some embodiments, a block may comprise a plurality of activities or updates and a hash of one or more previous block in the blockchain. In some embodiments, the system may comprise consensus rules for individual transactions and/or blocks and the node may work to form a block that conforms to the consensus rules of the system. In some embodiments, the consensus rules may be specified in the software program running on the node. For example, a node may be required to provide a proof standard (e.g. proof of work, proof of stake, etc.) which requires the node to solve a difficult mathematical problem for form a nonce in order to form a block. In some embodiments, the node may be configured to verify that the activity is authorized prior to working to form the block. In some embodiments, whether the activity is authorized may be determined based on records in the earlier blocks of the blockchain itself.

After step 902, if the node successfully forms a block in step 905 prior to receiving a block from another node, the node broadcasts the block to other nodes over the network in step 906. In some embodiments, in a system with incentive features, the first node to form a block may be permitted to add incentive payment to itself in the newly formed block. In step 920, the node then adds the block to its copy of the blockchain. In the event that the node receives a block formed by another node in step 903 prior to being able to form the block, the node works to verify that the activity recorded in the received block is authorized in step 904. In some embodiments, the node may further check the new block against system consensus rules for blocks and activities to verify whether the block is properly formed. If the new block is not authorized, the node may reject the block update and return to step 902 to continue to work to form the block. If the new block is verified by the node, the node may express its approval by adding the received block to its copy of the blockchain in step 920. After a block is added, the node then returns to step 901 to form the next block using the newly extended blockchain for the hash in the new block.

In some embodiments, in the event one or more blocks having the same block number is received after step 920, the node may verify the later arriving blocks and temporarily store these block if they pass verification. When a subsequent block is received from another node, the node may then use the subsequent block to determine which of the plurality of received blocks is the correct/consensus block for the blockchain system on the distributed database and update its copy of the blockchain accordingly. In some embodiments, if a node goes offline for a time period, the node may retrieve the longest chain in the distributed system, verify each new block added since it has been offline, and update its local copy of the blockchain prior to proceeding to step 901.

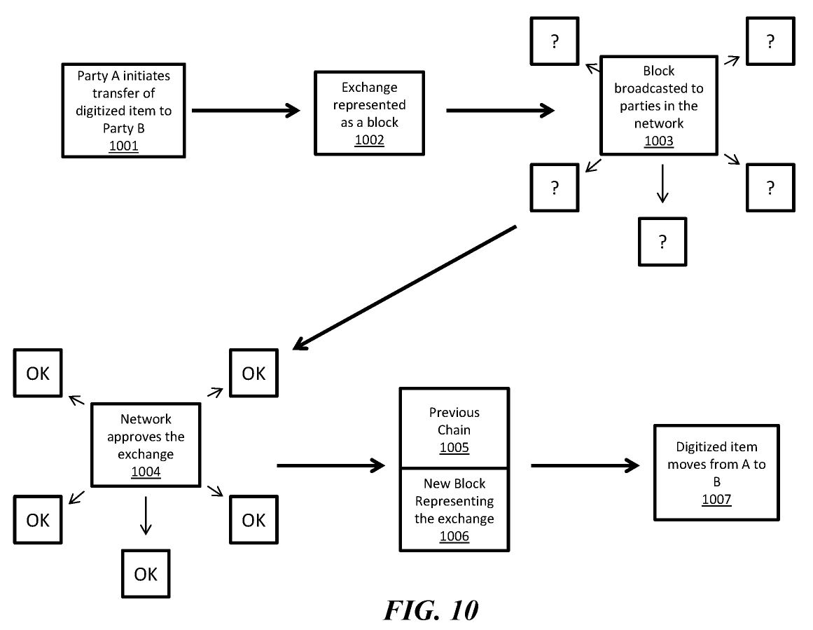

Now referring to FIG. 10, a process diagram a blockchain update according to some implementations in shown. In step 1001, party A initiates the transfer of a digitized item to party B. In some embodiments, the digitized item may comprise a digital currency, a digital asset, a document, rights to a physical asset, etc. In some embodiments, Party A may prove that he has possession of the digitized item by signing the transaction with a private key that may be verified with a public key in the previous transaction of the digitized item. In step 1002, the exchange initiated in step 1001 is represented as a block. In some embodiments, the transaction may be compared with transaction records in the longest chain in the distributed system to verify part A's ownership. In some embodiments, a plurality of nodes in the network may compete to form the block containing the transaction record. In some embodiments, nodes may be required to satisfy proof-of-work by solving a difficult mathematical problem to form the block. In some embodiments, other methods of proof such as proof-of-stake, proof-of-space, etc. may be used in the system. In some embodiments, the node that is first to form the block may earn a reward for the task as incentive. For example, in the Bitcoin system, the first node to provide prove of work to for block the may earn a Bitcoin. In some embodiments, a block may comprise one or more transactions between different parties that are broadcasted to the nodes. In step 1003, the block is broadcasted to parties in the network. In step 1004, nodes in the network approve the exchange by examining the block that contains the exchange. In some embodiments, the nodes may check the solution provided as proof-of-work to approve the block. In some embodiments, the nodes may check the transaction against the transaction record in the longest blockchain in the system to verify that the transaction is valid (e.g. party A is in possession of the asset he/she s seeks to transfer). In some embodiments, a block may be approved with consensus of the nodes in the network. After a block is approved, the new block 1006 representing the exchange is added to the existing chain 1005 comprising blocks that chronologically precede the new block 1006. The new block 1006 may contain the transaction(s) and a hash of one or more blocks in the existing chain 1005. In some embodiments, each node may then update their copy of the blockchain with the new block and continue to work on extending the chain with additional transactions. In step 1007, when the chain is updated with the new block, the digitized item is moved from party A to party B.

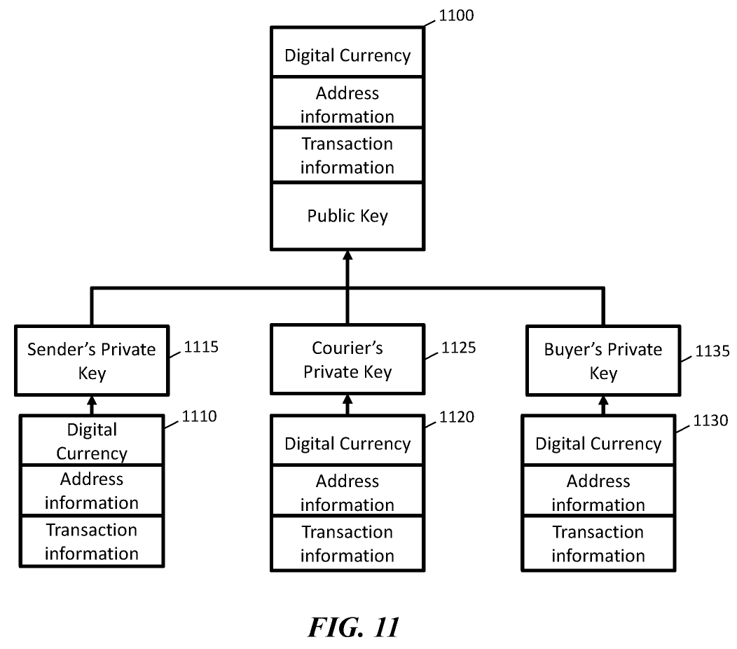

Now referring to FIG. 11, a diagram of a blockchain according to some embodiments in shown. FIG. 11 comprises an example of an implementation of a blockchain system for delivery service record keeping. The delivery record 1100 comprises digital currency information, address information, transaction information, and a public key associated with one or more of a sender, a courier, and a buyer. In some embodiments, nodes associated the sender, the courier, and the buyer may each store a copy of the delivery record 1110, 1120, and 1130 respectively. In some embodiments, the delivery record 1100 comprises a public key that allows the sender, the courier, and/or the buyer to view and/or update the delivery record 1100 using their private keys 1115, 1125, and the 1135 respectively. For example, when a package is transferred from a sender to the courier, the sender may use the sender's private key 1115 to authorize the transfer of a digital asset representing the physical asset from the sender to the courier and update the delivery record with the new transaction. In some embodiments, the transfer from the seller to the courier may require signatures from both the sender and the courier using their respective private keys. The new transaction may be broadcasted and verified by the sender, the courier, the buyer, and/or other nodes on the system before being added to the distributed delivery record blockchain. When the package is transferred from the courier to the buyer, the courier may use the courier's private key 1125 to authorize the transfer of the digital asset representing the physical asset from the courier to the buyer and update the delivery record with the new transaction. In some embodiments, the transfer from the courier to the buyer may require signatures from both the courier and the buyer using their respective private keys. The new transaction may be broadcasted and verified by the sender, the courier, the buyer, and/or other nodes on the system before being added to the distributed delivery record blockchain.

With the scheme shown in FIG. 11, the delivery record may be updated by one or more of the sender, courier, and the buyer to form a record of the transaction without a trusted third party while preventing unauthorized modifications to the record. In some embodiments, the blockchain based transactions may further function to include transfers of digital currency with the completion of the transfer of physical asset. With the distributed database and peer-to-peer verification of a blockchain system, the sender, the courier, and the buyer can each have confidence in the authenticity and accuracy of the delivery record stored in the form of a blockchain.

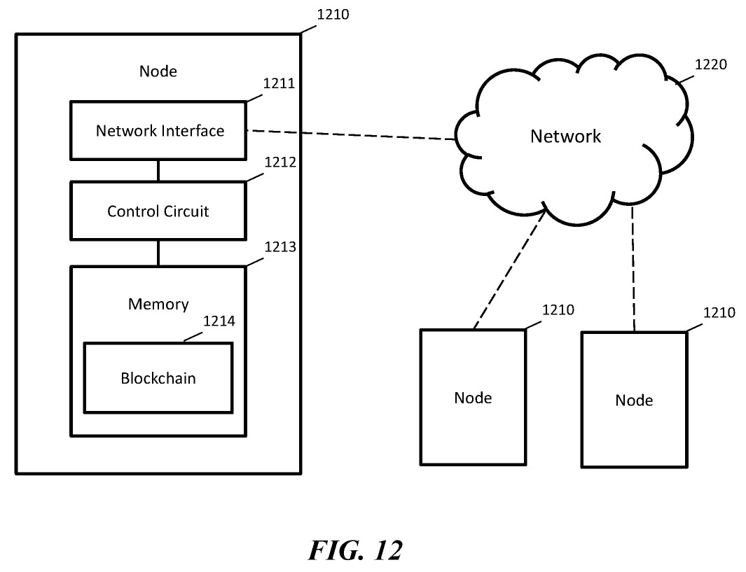

Now referring to FIG. 12, a system according to some embodiments is shown. A distributed blockchain system comprises a plurality of nodes 1210 communicating over a network 1220. In some embodiments, the nodes 1210 may be comprise a distributed blockchain server and/or a distributed timestamp server. In some embodiments, one or more nodes 1210 may comprise or be similar to a “miner” device on the Bitcoin network. Each node 1210 in the system comprises a network interface 1211, a control circuit 1212, and a memory 1213.

The control circuit 1212 may comprise a processor, a microprocessor, and the like and may be configured to execute computer readable instructions stored on a computer readable storage memory 1213. The computer readable storage memory may comprise volatile and/or non-volatile memory and have stored upon it a set of computer readable instructions which, when executed by the control circuit 1212, causes the node 1210 update the blockchain 1214 stored in the memory 1213 based on communications with other nodes 1210 over the network 1220. In some embodiments, the control circuit 1212 may further be configured to extend the blockchain 1214 by processing updates to form new blocks for the blockchain 1214. Generally, each node may store a version of the blockchain 1214, and together, may form a distributed database. In some embodiments, each node 1210 may be configured to perform one or more steps described with reference to FIGS. 9-10 herein.

The network interface 1211 may comprise one or more network devices configured to allow the control circuit to receive and transmit information via the network 1220. In some embodiments, the network interface 1211 may comprise one or more of a network adapter, a modem, a router, a data port, a transceiver, and the like. The network 1220 may comprise a communication network configured to allow one or more nodes 1210 to exchange data. In some embodiments, the network 1220 may comprise one or more of the Internet, a local area network, a private network, a virtual private network, a home network, a wired network, a wireless network, and the like. In some embodiments, the system does not include a central server and/or a trusted third party system. Each node in the system may enter and leave the network at any time.

With the system and processes shown in, once a block is formed, the block cannot be changed without redoing the work to satisfy census rules thereby securing the block from tampering. A malicious attacker would need to provide proof standard for each block subsequent to the one he/she seeks to modify, race all other nodes, and overtake the majority of the system to affect change to an earlier record in the blockchain.

In some embodiments, blockchain may be used to support a payment system based on cryptographic proof instead of trust, allowing any two willing parties to transact directly with each other without the need for a trusted third party. Bitcoin is an example of a blockchain backed currency. A blockchain system uses a peer-to-peer distributed timestamp server to generate computational proof of the chronological order of transactions. Generally, a blockchain system is secure as long as honest nodes collectively control more processing power than any cooperating group of attacker nodes. With a blockchain, the transaction records are computationally impractical to reverse. As such, sellers are protected from fraud and buyers are protected by the routine escrow mechanism.

In some embodiments, a blockchain may use to secure digital documents such as digital cash, intellectual property, private financial data, chain of title to one or more rights, real property, digital wallet, digital representation of rights including, for example, a license to intellectual property, digital representation of a contractual relationship, medical records, security clearance rights, background check information, passwords, access control information for physical and/or virtual space, and combinations of one of more of the foregoing that allows online interactions directly between two parties without going through an intermediary. With a blockchain, a trusted third party is not required to prevent fraud. In some embodiments, a blockchain may include peer-to-peer network timestamped records of actions such as accessing documents, changing documents, copying documents, saving documents, moving documents, or other activities through which the digital content is used for its content, as an item for trade, or as an item for remuneration by hashing them into an ongoing chain of hash-based proof-of-work to form a record that cannot be changed in accord with that timestamp without redoing the proof-of-work.

In some embodiments, in the peer-to-peer network, the longest chain proves the sequence of events witnessed, proves that it came from the largest pool of processing power, and that the integrity of the document has been maintained. In some embodiments, the network for supporting blockchain based record keeping requires minimal structure. In some embodiments, messages for updating the record are broadcast on a best-effort basis. Nodes can leave and rejoin the network at will and may be configured to accept the longest proof-of-work chain as proof of what happened while they were away.

In some embodiments, a blockchain based system allows content use, content exchange, and the use of content for remuneration based on cryptographic proof instead of trust, allowing any two willing parties to employ the content without the need to trust each other and without the need for a trusted third party. In some embodiments, a blockchain may be used to ensure that a digital document was not altered after a given timestamp, that alterations made can be followed to a traceable point of origin, that only people with authorized keys can access the document, that the document itself is the original and cannot be duplicated, that where duplication is allowed and the integrity of the copy is maintained along with the original, that the document creator was authorized to create the document, and/or that the document holder was authorized to transfer, alter, or otherwise act on the document.

As used herein, in some embodiments, the term blockchain may refer to one or more of a hash chain, a hash tree, a distributed database, and a distributed ledger. In some embodiments, blockchain may further refer to systems that uses one or more of cryptography, private/public key encryption, proof standard, distributed timestamp server, and inventive schemes to regulate how new blocks may be added to the chain. In some embodiments, blockchain may refer to the technology that underlies the Bitcoin system, a “sidechain” that uses the Bitcoin system for authentication and/or verification, or an alternative blockchain (“altchain”) that is based on bitcoin concept and/or code but are generally independent of the Bitcoin system.

Descriptions of embodiments of blockchain technology are provided herein as illustrations and examples only. The concepts of the blockchain system may be variously modified and adapted for different applications.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for managing a last mile delivery of an unmanned vehicle (UV) comprising:
a scout UV configured to perform a dry run delivery on one or more last mile routes to a delivery destination comprising:
a differential global positioning satellite (DGPS) receiver configured to:
receive positioning data from a satellite; and
receive positioning correction data from a DGPS base station;
an altimeter sensor configured to provide altitude data of the scout UV;
a distance sensor configured to provide distance data of obstacles along the one or more last mile routes;
a wind sensor configured to provide wind data along the one or more last mile routes; and
a scout control circuit coupled to the DGPS receiver, the altimeter sensor, the distance sensor, and the wind sensor, the scout control circuit configured to:
determine positional location coordinates of the scout UV based on the positioning data and the positioning correction data received by the DGPS receiver and the altitude data provided by the altimeter sensor during the dry run delivery over the one or more last mile routes;
determine perimeter coordinates of the obstacles along the one or more last mile routes based on the distance data, the wind data, and the positional location coordinates;
determine a trail of positional location coordinates based on the positional location coordinates of the scout UV and the perimeter coordinates of the obstacles, wherein the trail of positional location coordinates establishes a delivery path to be followed by a delivery UV over the one or more last mile routes during an actual delivery of one or more retail products associated with one or more retail orders to the delivery destination; and
provide the trail of positional location coordinates to the delivery UV; and
the delivery UV communicatively coupled to the scout UV, the delivery UV configured to follow the trail of positional location coordinates during the actual delivery of the one or more retail products to the delivery destination.

2. The system of claim 1, wherein each one of the perimeter coordinates defines one or more spatial boundaries of a particular obstacle, and wherein the one or more spatial boundaries corresponds to a threshold limit that the delivery UV is allowed to deviate from a portion of the trail of positional location coordinates proximate the particular obstacle.

3. The system of claim 1, wherein the trail of positional location coordinates comprises a series of global positioning satellite (GPS) coordinates starting from a first GPS coordinate corresponding to an outer edge of the one or more last mile routes and ending at a second GPS coordinate corresponding to the delivery destination.

4. The system of claim 3, wherein each GPS coordinate in the series of GPS coordinates is at least within a threshold value of a particular centimeter apart or fraction thereof from other GPS coordinates in the series of GPS coordinates.

5. The system of claim 1, wherein, in following the trail of positional location coordinates, the delivery UV is configured, on default, to expect no obstacle in the delivery path by following the trail of positional location coordinates.

6. The system of claim 5, wherein the scout control circuit is further configured to provide to the delivery UV the perimeter coordinates of the obstacles along the one or more last mile routes, and wherein the delivery UV is further configured to:
detect an unexpected obstacle blocking a portion of the delivery path along the trail of positional location coordinates;
consider a particular perimeter coordinate of the perimeter coordinates proximate the portion of the delivery path when avoiding the unexpected obstacle; and
provide an alert message to a main control circuit indicating the unexpected obstacle blocking the portion of the delivery path, and further comprising:
the main control circuit that is remote from and communicatively coupled to the delivery UV and the scout UV, the main control circuit configured to:
receive the trail of positional location coordinates from the scout UV; and
provide at least one of: a warning message to one or more other delivery UVs having another delivery path comprising the portion of the delivery path and a modified delivery path to the one or more other delivery UVs.

7. The system of claim 1, wherein the perimeter coordinates of the obstacles along the one or more last mile routes are determined over a plurality of different periods of time to account for varying wind data during a plurality of weather patterns, and wherein the scout control circuit is further configured to:
associate a particular determined perimeter coordinate of a particular obstacle with at least one of: a corresponding one of the varying wind data, a corresponding one of the plurality of weather patterns, and a corresponding one of a period of time; and
initiate storage of the associated particular determined perimeter coordinate of a plurality of associated particular determined perimeter coordinates to a database that is communicatively coupled to the scout control circuit.

8. The system of claim 7, wherein the scout control circuit is further configured to:
receive a forecasted weather pattern corresponding to the period of time of the actual delivery of the one or more retail orders to the delivery destination by the delivery UV; and
access the database to determine the particular determined perimeter coordinate corresponding to the particular obstacle and the weather pattern that is substantially matching the forecasted weather pattern, wherein the determination of the trail of positional location coordinates is further based on a particular perimeter coordinate corresponding to the particular obstacle and the forecasted weather pattern, wherein the one or more last mile routes comprises one or more routes having a threshold distance between an initial start of descent of the delivery UV to the delivery destination.

9. The system of claim 1, wherein the one or more last mile routes comprises one or more routes having a threshold distance that is between the delivery destination and about 300 feet from the delivery destination.

10. The system of claim 9, wherein the delivery UV is configured to start following the trail of positional location coordinates when the delivery UV reaches the threshold distance.

11. The system of claim 1, wherein the scout control circuit is further configured to communicate with the delivery UV over a blockchain network, wherein the trail of positional location coordinates is provided to the delivery UV over the blockchain network.

12. The system of claim 11, wherein the scout UV further comprises a low power radio frequency device configured to transmit the trail of positional location coordinates over the blockchain network.

13. A method for managing a last mile delivery of an unmanned vehicle (UV) comprising:
determining, by a scout control circuit of a scout UV, positional location coordinates of the scout UV based on positioning data and positioning correction data received from a differential global positioning satellite (DGPS) receiver and altitude data received from an altimeter sensor during a dry run delivery of the scout UV over one or more last mile routes;
determining, by the scout control circuit, perimeter coordinates of obstacles along the one or more last mile routes based on distance data received from a distance sensor, wind data received from a wind sensor, and the positional location coordinates;
determining, by the scout control circuit, a trail of positional location coordinates based on the positional location coordinates of the scout UV and the perimeter coordinates of the obstacles, wherein the trail of positional location coordinates establishes a delivery path to be followed by a delivery UV over the one or more last mile routes during an actual delivery of one or more retail orders to a delivery destination;
providing, by the scout control circuit, the trail of positional location coordinates to the delivery UV; and
following, by the delivery UV, the trail of positional location coordinates during the actual delivery of one or more retail products to the delivery destination.

14. The method of claim 13, wherein each one of the perimeter coordinates defines one or more spatial boundaries of a particular obstacle, and wherein the one or more spatial boundaries corresponds to a threshold limit that the delivery UV is allowed to deviate from a portion of the trail of positional location coordinates proximate the particular obstacle.

15. The method of claim 13, wherein the trail of positional location coordinates comprises a series of global positioning satellite (GPS) coordinates starting from a first GPS coordinate corresponding to an outer edge of the one or more last mile routes and ending at a second GPS coordinate corresponding to the delivery destination.

16. The method of claim 15, wherein each GPS coordinate in the series of GPS coordinates is at least within a threshold value of a particular centimeter value apart or fraction thereof from other GPS coordinate in the series of GPS coordinates.

17. The method of claim 13, wherein, in the following of the trail of positional location coordinates, the delivery UV is configured, on default, to expect no obstacle in the delivery path by following the trail of positional location coordinates.

18. The method of claim 17, further comprising:
providing, by the scout control circuit, to the delivery UV the perimeter coordinates of the obstacles along the one or more last mile routes;
detecting, by the delivery UV, an unexpected obstacle blocking a portion of the delivery path along the trail of positional location coordinates;
considering, by the delivery UV, a particular perimeter coordinate of the perimeter coordinates proximate the portion of the delivery path when avoiding the unexpected obstacle;
providing, by the delivery UV, an alert message to a main control circuit indicating the unexpected obstacle blocking the portion of the delivery path, wherein the main control circuit is remote from and communicatively coupled to the delivery UV and the scout UV;
receiving, by the main control circuit, the trail of positional location coordinates from the scout control circuit; and
providing, by the main control circuit, at least one of: a warning message to one or more delivery UVs having another delivery path comprising the portion of the delivery path and a modified mission data comprising a modified delivery path to one or more other delivery UVs.

19. The method of claim 13, wherein the perimeter coordinates of the obstacles along the one or more last mile routes are determined over a plurality of different periods of time to account for varying wind data during a plurality of weather patterns, and further comprising:
associating, by the scout control circuit, a particular determined perimeter coordinate of a particular obstacle with at least one of: a corresponding one of the varying wind data, a corresponding one of the plurality of weather patterns, and a corresponding one of a period of time; and
initiating, by the scout control circuit, storage of the associated particular determined perimeter coordinate of a plurality of associated particular determined perimeter coordinates to a database that is communicatively coupled the scout control circuit and a main control circuit.

20. The method of claim 19, further comprising:
receiving, by the scout control circuit, forecasted weather pattern corresponding to the period of time of the actual delivery of the one or more retail orders to the delivery destination by the delivery UV; and
accessing, by the scout control circuit, the database to determine the particular determined perimeter coordinate corresponding to the particular obstacle and the weather pattern that is substantially matching the forecasted weather pattern, wherein the determining of the trail of positional location coordinates is further based on the particular perimeter coordinate corresponding to the particular obstacle and the forecasted weather pattern, wherein the one or more last mile routes comprises one or more routes having a threshold distance between an initial start of descent of the delivery UV to the delivery destination.

21. The method of claim 13, wherein the one or more last mile routes comprises one or more routes having a threshold distance that is between the delivery destination and about 300 feet from the delivery destination, and wherein, prior to the following of the trail of positional location coordinates, determining, by the delivery UV, whether the delivery UV has reached the threshold distance.

22. The method of claim 13, further comprising:
obtaining, by the scout control circuit, multiple different sets of weather patterns during each of a corresponding one of multiple different periods of time of different seasons of a year; and
obtaining, by the scout control circuit, for each set of the multiple different sets of weather patterns corresponding different sets of wind data.

23. The method of claim 13, further comprising, in providing the trail of positional location coordinates to the delivery UV, transmitting over a blockchain network, by the scout control circuit to the delivery UV, the trail of positional location coordinates through a low power radio frequency device of the scout UV.
